(19) United States
(12) Patent Application Publication
(10) Pub. No.: US 2023/0034021 A1
(43) Pub. Date: Feb. 2, 2023

(54) SELF-SERVICE CHECKOUT TERMINAL, METHOD AND CONTROL DEVICE

(71) Applicant: Wincor Nixdorf International GmbH, Paderborn (DE)

(72) Inventors: Eduard WEIS, Paderborn (DE); Alexander KNOBLOCH, Paderborn (DE); Sebastian ENGELNKEMPER, Langenberg (DE)

(21) Appl. No.: 17/786,279

(22) PCT Filed: Dec. 9, 2020
(86) PCT No.: PCT/EP2020/085197

§ 371 Date: Jun. 16, 2022

(30) Foreign Application Priority Data
Dec. 17, 2019 (EP) 19217197.3

(51) Int. Cl. G06Q 20/40; G06Q 20/18; G06Q 20/20; G06V 40/40; G06V 40/16; G06T 7/50

(52) U.S. Cl. CPC G06Q 20/40145; G06Q 20/18; G06Q 20/206; G06Q 20/405; G06V 40/40; G06V 40/161; G06T 7/50; G06V 40/178; G06V 40/162; G06V 2201/12

(57) ABSTRACT

In accordance with various embodiments, a self-service checkout terminal can comprise: a capture device having at least one sensor, wherein the capture device is configured: to capture first biometric data with reference to a person at the self-service checkout terminal; to capture second biometric data with reference to an official identity certificate if the identity certificate is presented to the capture device; to capture a product identifier of a product if the product is presented to the capture device; a control device configured for: firstly determining a sales restriction to which the product is subject, on the basis of the product identifier; comparing the first biometric data with the second biometric data; secondly determining whether the person satisfies a criterion of the sales restriction on the basis of a result of the comparing and on the basis of the second biometric data.

### CROSS-REFERENCE TO RELATED APPLICATIONS

This application is a National Phase filing of International Application Ser. No. PCT/EP2020/085197, for a Self-service checkout terminal, method and control device, filed 9 Dec. 2020.

### BACKGROUND

Various exemplary embodiments relate to a self-service checkout terminal, to a method and to a control device.

A checkout terminal can afford customers the possibility of scanning the desired products themselves (e.g. without assistance) or alternatively of receiving assistance from an employee when scanning the products. Although such a self-service checkout terminal causes a longer checkout and payment procedure, in return it ensures more anonymity for customers, a shortening of the time waiting in a queue, a higher throughput relative to the entire branch and lower personnel costs for the retail trade. With a self-service checkout terminal, the bar codes of the products to be bought are not necessarily scanned by a cashier, but rather by each of the customers themselves.

Unfortunately, when a self-service checkout terminal is used, not all of the procedures that are normally undertaken by the cashier can be automated without problems. These include the procedure of age verification, for example, which is intended to check whether the customer is of the requisite age to be permitted to purchase a product whose sale is subject to an age restriction. Therefore, it is conventional practice for the age verification still often to be carried out by an employee, which is relatively reliable, but lengthy and cost-intensive. A mechanism for automated age verification estimates the age in an automated manner, e.g. by means of an algorithm. However, the latter can easily be manipulated, e.g. by means of make-up or an unnatural facial expression. As an alternative, all that is required is to present an identity card, which can likewise be manipulated by someone else's identity card being presented. In particular, the latter alternative has very little legal acceptance, i.e. in only few countries and only for few products, for example cigarettes in Germany.

### SUMMARY

In accordance with various embodiments, it has been recognized illustratively that the sale of goods with an age restriction at self-service checkouts is conventionally susceptible to errors and/or laborious and costly. The description appertaining to the age restriction can analogously also apply to any other sales restriction.

In accordance with various embodiments, it has been recognized illustratively that the age verification procedure can be improved, for example without contravening legal provisions or data protection provisions. This is done illustratively by reading (e.g. optically) the identity card, e.g. its photograph and text, and, on the basis thereof, carrying out facial recognition and determining the age of the person of the identity card. Furthermore, facial recognition of the person in front of the self-service checkout is carried out and a check is made to ascertain whether the person of the identity card (e.g. the owner thereof) and the person of the customer are identical, i.e. whether the latter is also the owner of the identity card. If this is all correct, the sale of the product with an age restriction can be enabled. By way of example, the actual mode of operation of the age verification can thus be more easily understandable, in contrast to trained algorithms for age estimation, and incorrect decisions can be avoided.

In accordance with various embodiments, a self-service checkout terminal, a method and a control device which facilitate the procedure of age verification are provided. By way of example, automation of age verification is facilitated, e.g. by the exact age being read from a personal identity card and/or by the authenticity of the identity card being checked with reference to the security features thereof.

In accordance with various embodiments, legitimate possession can be checked by way of a biometric 1:1 comparison of a photograph (from the personal identity card) and a live image (e.g. by means of a camera at the checkout terminal). Furthermore, a manipulation (for example of the live image) by way of previously recorded images can be made more difficult, e.g. by depth information being evaluated and/or a neural network additionally being used. A manipulation can take place only by way of high-quality document forgery, for example, against which manual age verification is also essentially powerless.

### BRIEF DESCRIPTION OF THE DRAWINGS

In the figures:

FIG. 1 shows a method in accordance with various embodiments in a schematic flow diagram;

FIG. 2 shows a checkout terminal in accordance with various embodiments in a schematic construction diagram;

FIG. 3 shows a checkout terminal in accordance with various embodiments in a schematic communication diagram;

FIG. 4 shows a checkout terminal in accordance with various embodiments in a schematic side view;

FIG. 5 shows a checkout terminal in accordance with various embodiments in a method in a schematic side view;

FIG. 6 shows a method in accordance with various embodiments in a schematic flow diagram; and

FIG. 7 shows a method in accordance with various embodiments in a schematic flow diagram.

### DETAILED DESCRIPTION

In the following detailed description, reference is made to the accompanying drawings, which form part of this description and show for illustration purposes specific embodiments in which the invention can be implemented. In this regard, direction terminology such as, for instance, “at the top”, “at the bottom”, “at the front”, “at the back”, “front”, “rear”, etc. is used with respect to the orientation of the figure(s) described. Since components of embodiments can be positioned in a number of different orientations, the direction terminology serves for illustration and is not restrictive in any way whatsoever. It goes without saying that other embodiments can be used and structural or logical changes can be made, without departing from the scope of protection of the present invention. It goes without saying that the features of the various exemplary embodiments described here can be combined with one another, unless specifically indicated otherwise. Therefore, the following detailed description should not be interpreted in a restrictive sense, and the scope of protection of the present invention is defined by the appended claims.

In the context of this description, the terms “connected”, “attached” and “coupled” are used to describe both a direct and an indirect connection (e.g. resistively and/or electrically conductively, e.g. a communication-enabled connection), a direct or indirect attachment and a direct or indirect coupling. In the figures, identical or similar elements are provided with identical reference signs, insofar as this is expedient.

The term “control device” can be understood as any type of entity which implements logic and which can comprise a circuitry interconnection and/or a processor, for example, which can execute software stored in a storage medium, in firmware or in a combination thereof and can output instructions on the basis thereof. The control device can be configured by means of code segments (e.g. software), for example, in order to control the operation of a system (e.g. the operating point thereof), e.g. of a machine or an apparatus, e.g. the components thereof.

The term “processor” can be understood as any type of entity which allows data or signals to be processed. The data or signals can be handled for example in accordance with at least one (i.e. one or more than one) specific function executed by the processor. A processor can comprise or be formed from an analog circuit, a digital circuit, a mixed-signal circuit, a logic circuit, a microprocessor, a central processing unit (CPU), a graphics processing unit (GPU), a digital signal processor (DSP), a programmable gate array (FPGA), an integrated circuit or any combination thereof. Any other type of implementation of the respective functions described more thoroughly below can also be understood as a processor or logic circuit. It is understood that one or more of the method steps described in detail herein can be implemented (e.g. realized) by a processor, by means of one or more specific functions executed by the processor. The processor can therefore be configured to carry out one of the methods described herein or the components thereof for information processing.

In accordance with various embodiments, a data memory (more generally also referred to as a storage medium) can be a non-volatile data memory. The data memory can comprise or be formed from a hard disk and/or at least one semiconductor memory (such as e.g. read only memory, random access memory and/or flash memory), for example. The read only memory can be for example an erasable programmable read only memory (can also be referred to as EPROM). The random access memory can be a non-volatile random access memory (can also be referred to as NVRAM—“non-volatile random access memory”). For example, one or more than one of the following can be stored in the data memory: a database (can also be referred to as a reference database), a processing algorithm; a criterion; code segments which implement for example one or more than one processing algorithm (also referred to as algorithm for simplification). The database can comprise one or more data sets, each data set of which assigns a product identifier to an item of payment information and/or a sales restriction. This can be read out by the control device.

Reference is made hereinafter to image data and the processing thereof. The image data can be a digital image representation of reality (e.g. of the capture region) at a point in time of capturing the image data. The imaging of reality can be effected by means of a lens, for example, which projects light onto the surface of an image capture sensor (e.g. a Bayer sensor). Capturing the image data can comprise reading the image capture sensor while the light is projected onto the surface thereof. The image data thus obtained can initially be in the so-called raw data format (also referred to as RAW), which comprises pixel by pixel the measured values read out from the image capture sensor, and/or be processed as such. The image data can optionally be or have been converted into a different image format during processing, e.g. into raster graphics (different than RAW as raster graphics) or vector graphics, such that their further processing takes place in this image format, or they can be converted arbitrarily between these. The converting can optionally comprise interpolating the measured values from the image capture sensor (e.g. by means of demosaicing), e.g. in order to obtain complete multicolored color information for each pixel or in order to require less memory space or computing power. The image data can optionally be compressed (e.g. in order to require less memory space or computing power) or uncompressed (e.g. in order to avoid corruption). The respective image format can also define the color space according to which the color information is specified.

The simplest case is a binary color space, in which one black-and-white value is stored per pixel. In the case of a somewhat more complex color space (also referred to as grayscale color space), intermediate levels between black and white are stored (also referred to as grayscale values). However, the color space can also be spanned by a plurality of (e.g. two or more) primary colors, such as red, green and blue, for example. If the measured values are intended to comprise multicolored color information, for example, a wavelength-sensitive image capture sensor can be used. The measured values thereof can be coded in accordance with a color space, for example. The color information or the underlying color space can therefore be multicolored (also referred to as polychromatic) or else single colored (also referred to as monochromatic). The monochromatic color information can for example comprise only grayscale values (then also referred to as grayscale value information) or comprise black-and-white values (then also referred to as black-and-white value information) which represent the intensity of the captured radiation at the wavelength or in the wavelength range for which the monochromatic sensor is sensitive. For visual rendering of the image data on a display device, said image data are converted into that image format which is predefined by the image memory of the graphics card. For ease of understanding, the image data described herein are represented as such visual rendering. In general, the image data, e.g. stored in a storage medium, can be present as a file (also referred to as a digital image or image file) in the respective image format.

The image data can furthermore be assigned (e.g. as an alternative or in addition to the color information) depth information (also referred to as 3D information). A so-called 3D camera can be used for capturing the depth information, as will be described in even greater detail later. The measured values of the 3D camera can comprise (e.g. pixel by pixel) information concerning a topography of the imaged reality (also referred to as depth information). By way of example, the depth information can specify the distance between a or each pixel of the camera and a location in space that is imaged onto the pixel.

The depth information can illustratively add a third spatial dimension (referred to as depth herein) to the two spatial dimensions represented by the image data. By way of example, by means of the image data, an object can be represented as a projection onto the two-dimensional surface of the image sensor (also referred to as 2D image data). In addition to this, the depth information spans the third spatial dimension. By way of example, the depth information can comprise values (also referred to as depth values) which are assigned to the image data segmentwise (i.e. for each segment of the image data) and which indicate the depth thereof. By way of example, the depth information can comprise depth values which are assigned to the image data pixelwise (i.e. for each pixel of the image data) and which indicate the depth.

In accordance with various embodiments, the depth information is obtained by means of three-dimensional (3D) image capture. The depth information can be used for example to recognize whether an object is situated outside or behind (viewed from the image capture device) a reference plane. The spatial distance from the reference plane at which an object is situated can thus be distinguished. By way of example, it is possible to obtain the depth information through the entire capture region, such that illustratively from the side it is possible to recognize the spatial position of one or more than one object relative to the reference plane. The reference plane can be oriented along the direction of gravity, for example, if one or more than one perspective of the image capture device runs transversely with respect to the direction of gravity. In more general terms, the reference plane can run along a direction that is transverse with respect to the or each perspective of the image capture device. By way of example, the image data can also be captured obliquely from above.

In accordance with various embodiments, the image capture device can provide image data of the capture region from a plurality of optical perspectives (e.g. provided by means of a plurality of lenses) which represent depth information of the capture region (e.g. stereoscopically). In order to determine the depth information, the image data captured from different perspectives (e.g. by means of a plurality of lenses) can be superposed on one another, e.g. taking account of a relative spatial pose (position and/or orientation) of the lenses with respect to one another. A camera can comprise an (optical) image capture sensor and at least one lens (also referred to as a lens arrangement) assigned to the image capture sensor. The lens arrangement of a plenoptic camera may also comprise a grid of a plurality of micro lenses. By way of example, the image capture device (e.g. RealSense F200, INTEL R200, Intel RealSense D415, Intel RealSense D435 and/or Intel SR300) can comprise an RGB image capture sensor and/or a 3D image capture sensor.

An image capture sensor (also referred to as an image sensor) is of the optical sensor type and can comprise one or more photoelectrically active regions (can also be referred to as pixels) which generate and/or modify an electrical signal e.g. in response to electromagnetic radiation (e.g. light, e.g. visible light). The image capture sensor can comprise or be formed from a CCD sensor (charge-coupled device sensor) and/or an active pixel sensor (can also be referred to as CMOS sensor), for example. Optionally, an image capture sensor can be configured in a wavelength-sensitive fashion (e.g. for capturing color information), e.g. by means of a plurality of color filters (e.g. in grid form), and can thus distinguish between different wavelengths.

The depth information can be quantified, e.g. with indication of the depth as value (also referred to as depth value), can be coded or can itself be provided by means of image data, e.g. by assignment of image data captured simultaneously from a different perspective (e.g. separately from one another or superposed on one another). The plurality of simultaneously captured perspectives can be superposed on one another, for example, in order to quantify the depth information. Each depth value of the depth information can then correspond for example to a deviation between the plurality of simultaneously captured perspectives.

The image data can optionally be segmented using the depth information (also referred to as 3D-based segmentation), e.g. by the image data being subdivided into segments (e.g. pixels) of two types, depending on whether or not the depth values assigned to the segments satisfy a criterion. By way of example, the depth values of the segments of a first type may satisfy the criterion and the depth values of the segments of a second type may not satisfy the criterion. Optionally, more than two types can be used, if for example more than one criterion is used. The boundaries between the segments of the image data run along those depth values which substantially conform to the criterion.

By means of a 3D-based segmentation of the image data and living recognition by means of an artificial neural network (ANN), the age verification can be simplified, improved and/or safeguarded. By way of example, only those segments of the image data whose depth values satisfy a criterion (e.g. illustratively are as close as possible to the checkout terminal) can be fed to the living recognition. In this regard, firstly the case of fraud can be prevented, and secondly the overall process can be analyzed for deviations from normal behavior. Thus the entire checkout process (also referred to as checkout procedure) can optionally be assessed in respect of its suspiciousness and/or optionally an employee can be informed.

On account of the preprocessing of the image data by means of a depth-based segmentation and also a targeted optimization of the architecture of the ANN to the given problem formulation, very high recognition rates can be achieved in comparison with conventional mechanisms. Alternatively or additionally, on account of the preprocessing of the image data by means of a depth-based segmentation (also referred to as depth segmenting) and also a targeted optimization of the architecture of the ANN to the given problem formulation, more cost-effective hardware can be made possible in comparison with conventional mechanisms. Illustratively, less computing power is necessary to achieve high recognition rates.

In accordance with various embodiments, a checkout terminal can be configured to register the products that a customer wants to purchase, e.g. to capture them by means of scanning the products on a scanner (e.g. a barcode scanner). Furthermore, the checkout terminal can comprise a (e.g. digital) cash register system (for example comprising a self-service cash register or a cashier workstation) configured to carry out a payment process. The payment process can comprise for example the customer actually paying for the products to be purchased. The cash register system can comprise at least one of the following: a screen (e.g. a touch-sensitive screen), a printer (e.g. for printing out an invoice and/or a label), a (e.g. programmable) cash register keyboard (can also be part of the touch-sensitive screen), a payment means terminal for accepting a payment means (e.g. cash or a debit card). The payment means terminal can be for example an electronic payment means terminal (can also be referred to as EC terminal, “EC”—electronic cash, e.g. for reading a debit card and/or a credit card). By way of example, the checkout terminal can comprise a (e.g. digital) cash register system configured to carry out one or more cash register system processes, such as a checkout session, for example. A checkout session can comprise for example a calculating process, an inventory process and/or a checkout process.

In the case of a self-service checkout terminal, the cash register system and the scanner can be arranged on the same side (e.g. of a pole) of the checkout terminal, such that they can be operated from one position. In the case of a non-self-service checkout terminal (also referred to as cashier checkout terminal), the cash register system and the scanner can be operable from different sides, e.g. the scanner can be operable from a cashier workstation.

With regard to the implementation of the method, reference is made herein, inter alia, to a self-service checkout terminal. It may be understood that the description given can analogously apply to a non-self-service checkout terminal or some other terminal (e.g. self-service terminal), and vice versa.

The terminal can be for example a self-service kiosk or an automatic vending or dispensing machine (e.g. for a casino, pharmacy, cinema, etc.) or some other automated kiosk. The terminal need not necessarily be configured for capturing a product identifier, but rather can also read it out from a memory, e.g. in accordance with a user input. The user input can illustratively indicate what product (kept available by the terminal, for example) the customer would like to purchase. For this purpose, the terminal can comprise for example a storage area for storing one or more than one physical product (which the customer can purchase by way of user input, for example). The terminal can for example determine the product identifier in accordance with the user input and/or eject the product accordingly, provided that the payment procedure process has been enabled and/or concluded. The user input can comprise for example button pressing or some other physical action by a user on the terminal, e.g. also coin insertion (if the terminal keeps available e.g. only identical products).

Hereinafter, reference is made to products (e.g. goods, may also be referred to as articles) as objects. The description given can analogously also apply to other objects which for example can be transported in a transport container. The product can generally be a physical product, but also a virtual product.

Hereinafter, reference is made, inter alia, to the process of facial recognition. Facial recognition can comprise determining visible features in the region of the frontal head (also referred to as face), e.g. the characteristic form thereof (e.g. shape and/or size), relative spatial parameters (e.g. position, distance and/or orientation) and/or the surface texture thereof, or the like. Examples of visible features comprise: eyes, nose, ears, mouth, contours, skin unevennesses (such as wrinkles, for example), etc.

In an implementation with little complexity, the facial recognition can be effected on the basis of a two-dimensional measurement of the image data, for example for determining spatial parameters (e.g. position, distance and/or orientation) of the features. In order to increase the accuracy with which the facial recognition is effected, further parameters can be determined, such as the characteristic form and/or texture thereof. Analogously to this, a three-dimensional measurement of image data can also be effected. For this purpose, the image data can comprise depth information, for example, which is fed to the facial recognition. By way of example, facial recognition that carries out a three-dimensional measurement can inherently carry out living recognition.

As a result of the facial recognition, a set of features (also referred to as facial features for simplification) can be obtained, which can be stored and/or processed further. Every facial recognition can yield such a set of features, which can be compared with another set of features, for example.

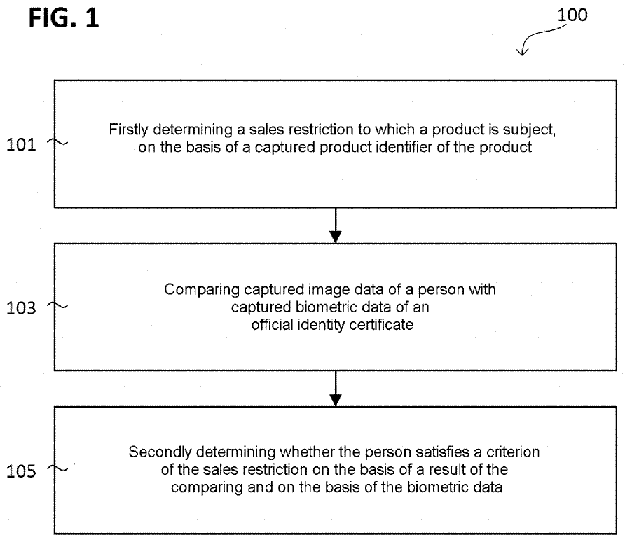

FIG. 1 illustrates a method 100 in accordance with various embodiments in a schematic flow diagram.

Hereinafter, reference is made to capturing and processing image data of the person. In more general terms, as an alternative or in addition to the image data of the person, other biometric data of the person can also be captured and/or processed, with reference to the person himself/herself. It may be understood that the description appertaining to the image data of the person can analogously hold true for the other biometric data (e.g. concerning biometric identification features) which are captured with reference to the person, for example for: facial features (e.g. determined on the basis of image data of the face) of the person, a fingerprint image of the person, a genetic fingerprint of the person, iris features (i.e. features of the iris) of the person, ocular fundus features (i.e. features of the retina) of the person, a height of the person, nail bed patterns of the person, signature features of the person, a voice profile of the person (e.g. enabling speaker authentication), etc.

The method 100 can comprise, in 101, firstly determining a sales restriction to which a product is subject, on the basis of a captured product identifier of the product; in 103, comparing captured image data of a person (e.g. a user of a checkout terminal) with captured biometric data of an official identity certificate; and in 105, secondly determining whether the person satisfies a criterion of the sales restriction on the basis of a result of the comparing and on the basis of the biometric data. Secondly determining can comprise restriction comparing 903, as will be described in even greater detail later.

The biometric data (e.g. concerning biometric identification features) of the person can be captured directly by means of a corresponding biometric sensor and/or be determined with reference to sensor data provided by the sensor (for example in the case of facial features). The biometric data (e.g. concerning biometric identification features) captured with reference to the identification certificate can be selected in an appropriately matching manner. By way of example, the biometric data (e.g. concerning biometric identification features) of the person and of the identification certificate can be of the same type or at least comparable.

The method 100 can optionally comprise determining a validity of the identity certificate, wherein the criterion of the sales restriction is not satisfied, for example, if it is determined that the identity certificate is invalid (e.g. expired or falsified). Determining the validity of the identity certificate can comprise capturing one or more than one security feature of the identity certificate and/or capturing an expiry date of the identity certificate. Examples of a security feature comprise: a security feature which is visible only in infrared light (which is excited to be luminous e.g. by means of infrared light), a security feature which is visible only in ultraviolet light (which is excited to be luminous e.g. by means of ultraviolet light), a security feature which emits only in a non-visible wavelength range (for example above 780 nm and/or below 380 nm).

Determining the validity of the identity certificate can be effected by means of optical capture, for example. Analogously, capturing the biometric data of the identity certificate or else other data of the identity certificate (e.g. the expiry date thereof) can be effected by means of optical capture, as will be described in even more specific detail later.

Reference is made herein to optical capture of the identity certificate, such that image data of the identity certificate are obtained and processed, with reference to which for example the biometric data and/or the validity of the identity certificate can be determined. The description appertaining to optical capture can analogously apply to electrical capture, such that the corresponding information (e.g. image data, biometric data and/or a verification of validity) is read out from a storage medium of the identity certificate.

By way of example, capturing the biometric data can comprise optically capturing the identity certificate (e.g. by means of an image capture device), as will be described in more specific detail below. The identity certificate can be optically captured for example on one side or on both sides (e.g. simultaneously from both sides). Capture on one side is easier to implement. Capture on two sides increases the number of captured data and thus the reliability.

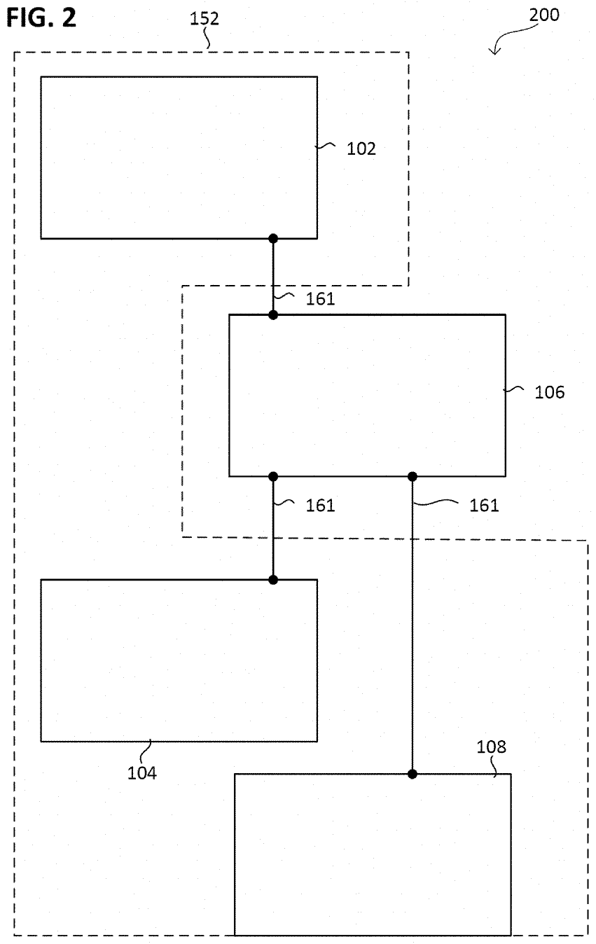

FIG. 2 illustrates a checkout terminal 200 in accordance with various embodiments in a schematic construction diagram. The checkout terminal 200 can comprise a capture device 152 (also referred to as data capture device) and a control device 106. The control device 106 can be configured to implement the method 100, as will be described by way of example below.

The capture device 152 can comprise as components, for example, an image capture device 102, a certificate capture device 108 and/or a product capture device 104.

The control device 106 can be communicatively 161 coupled to the capture device 152, e.g. to each of its components 102, 104, 108 (if present), e.g. by means of a field bus communication network 161.

The capture device 152 can be configured to capture data of various types (also referred to as data type), such as, for example: image data of a person at the self-service checkout terminal (for example as first data type); biometric data of an official identity certificate (for example as second data type) if the identity certificate is presented to the capture device; and/or a product identifier of a product (for example as third data type) if the product is presented to the capture device. For the purpose of capturing the data, the capture device 152 can comprise one or more than one sensor, each sensor of which is configured to capture data of one or more than one data type.

The capture device 152 and/or the control device 106 can comprise a corresponding infrastructure (e.g. comprising processor, storage medium and/or bus system) or the like which implements a measuring chain. The measuring chain can be configured to actuate the corresponding sensors (e.g. camera, scanner, etc.), to process the measurement variable thereof as input variable and, on the basis thereof, to provide the image data and/or product identifier as output variable.

To facilitate understanding, reference is made hereinafter, inter alia, to a capture device 152, the components of which can provide separate infrastructures (e.g. sensors or measuring chains), e.g. respectively for capturing the product identifier, for capturing the image data of the person and for capturing the biometric data of the official identity certificate. In general, the control device 106 and the capture device 152 or the components 102, 104, 108 thereof need not necessarily be separate from one another or comprise separate infrastructures. By way of example, a plurality of information processing functions can also be provided as components of the same software (also referred to as application) which is executed by one or more than one processor of the checkout terminal 200. It goes without saying that it is also possible to use a plurality of applications and/or a plurality of processors (e.g. an interconnection thereof, e.g. also interconnected via a network) which provide the information processing functions of the capture device 152 (e.g. the components thereof) and of the control device 106. Analogously, a plurality of data capturing functions can be provided as components of the same measuring chain. By way of example, the same sensor can be configured for capturing a plurality of the data types.

The description appertaining to the separate sensors or measuring chains can therefore analogously hold true if one or more than one of the data capturing and/or information processing functions (e.g. two or more than two of these components) are provided jointly by means of the same infrastructure (e.g. a sensor and/or a measuring chain) or intermeshing infrastructures.

Examples of possible configurations are explained below.

In a first exemplary configuration, the capture device 152 comprises: an image capture device 102 having an image sensor (e.g. CCD sensor) configured to capture the image data of the person, a certificate capture device 108 having a second sensor configured to capture the biometric data, and a product capture device 104 having a third sensor configured to capture the product identifier. This achieves separate sensors/infrastructures and thus a greater variability, for example in the case of maintenance and/or equipment set-up.

In a modification of the first exemplary configuration, as sensor of the certificate capture device 108 it is possible to use a or the image sensor configured to capture image data of the identity certificate, wherein the certificate capture device 108 is configured to extract the biometric data from said image data (e.g. by means of pattern recognition, such as, for example, facial recognition and/or text recognition). As a consequence of this, there is no intervention in possibly existing sovereign authority for reading out the biometric data (e.g. legal provisions).

In a modification of the first exemplary configuration, as an alternative or in addition to the image sensor, the certificate capture device 108 can comprise a smart card reader configured to read out biometric data stored on the identity certificate (e.g. the storage medium thereof). As a consequence of this, the biometric data are obtained digitally and with high quality.

In a second exemplary configuration, the capture device 152 comprises: an image capture device having the image sensor configured to capture the image data of the person and the image data of the identity certificate, wherein the capture device 152 is configured to extract the biometric data from the latter image data, and a product capture device 104 having the third sensor for capturing the product identifier.

In a modification of the first and/or second exemplary configuration, as sensor of the product capture device 104, it is possible to use a or the image sensor configured to capture image data of the product, wherein the product capture device 104 is configured to extract the product identifier from said image data.

In a modification of the first and/or second exemplary configuration, as an alternative or in addition to the image sensor, the product capture device can comprise a machine code reading device (e.g. a barcode reader) configured to capture (e.g. optically) a machine-readable code of the product, wherein the product capture device is configured to extract the product identifier therefrom.

In a third exemplary configuration, the capture device 152 comprises only one image sensor configured to capture the image data of the person, to capture the image data of the identity certificate (wherein the capture device 152 extracts the biometric data from the latter image data), and to capture the image data of a product capture device 104 (wherein the capture device 152 extracts the product identifier from the latter image data).

Other exemplary configurations are described below.

By way of example, the identity certificate can comprise one or more than one machine-readable zone (e.g. pursuant to specification 9303 of the International Civil Aviation Organization, of the European Union, for identification documents) which is captured optically (e.g. image data thereof). With reference to the or each optically captured machine-readable zone, it is possible to determine for example the biometric data of the identity certificate, e.g. a date of birth. In other words, the identity certificate itself can comprise a machine-readable code which can be captured by means of a or the machine code reading device for the purpose of providing the biometric data (e.g. by means of optical text recognition).

The or each image sensor of the capture device 152 or the image capture device 102 thereof can define for example a capture region in front of the checkout terminal 200, said capture region (and optionally objects and/or persons arranged therein) being represented by the captured image data. The or each image sensor of the capture device 152 or the image capture device 102 thereof can be configured to feed the image data (e.g. in the raw data format or a preprocessed version of the raw data format), e.g. pixel-based image data (also referred to as raster graphics). The or each image capture device 102 can comprise for example one or more than one camera comprising one or more than one image sensor.

The capture device 152 (e.g. the product capture device 104 thereof) can be configured to feed a product identifier captured by it to the control device 106. The product identifier can be uniquely assigned to a product or the type thereof, for example. The product identifier can be determined for example on the basis of an optical feature (also referred to as identifier feature) of the product which is captured. The identifier feature (e.g. a pattern) can comprise a visual code representing the product identifier, e.g. a binary code or the like. By way of example, the identifier feature can comprise a barcode or some other machine-readable code.

By means of the capture device 152 (e.g. the product capture device 104 thereof), the individual product identifiers can be determined product by product (also referred to as identifier capturing). The region in which the capture device 152 can capture the product can be a product capture zone, for example. The identifier capturing can comprise presenting a product to be captured to the capture device 152. The presenting can comprise arranging the product to be captured in the product capture zone and orienting the identifier feature of said product in the direction of the capture device 152.

By way of example, the capture device 152 (e.g. the product capture device 104 thereof) can comprise an optical capture device, an RFID scanning device (radiofrequency identification) or the like for the purpose of capturing the product identifier. The optical capture device can comprise for example a barcode scanning device, an image capture device or an image scanning device. The barcode scanning device can include corresponding sensors for implementing a scanning functionality, such as, for example, one or more than one infrared sensor, one or more than one camera and the like. The product capture device 104 can be configured for example to capture the machine-readable code and to be able to process it in order to extract the product identifier therefrom.

The capture device 152 (e.g. the image capture device 102 thereof) can be configured to determine image data of the person, wherein the image data can comprise color information and/or depth information. For this purpose, the image capture device 102 can comprise a 3D camera and/or an RGB camera, as will be described in even more specific detail below.

As described above, one or more than one camera can be used to capture the image data of the identification certificate and the image data of the person in front of the checkout terminal. These image data can be captured for example successively by means of the same camera, e.g. by the person first presenting himself/herself and then presenting the identification certificate, or vice versa. However, these image data can likewise be captured simultaneously by means of the same camera, e.g. by the person holding the identification certificate next to himself/herself when presenting himself/herself.

One easily understandable example for implementing the method 100 can comprise capturing data of the personal identity card and a live image of the person (e.g. successively or simultaneously). Optionally, it is possible to output a request to the person to look into the camera (alternatively or additionally, however, it is also possible for filming to be effected permanently, e.g. without the person's knowledge). Optionally, a stencil can be inserted as a positioning template.

The camera for capturing the image data of the person can for example also be arranged in or on the certificate capture device 108, e.g. the smart card reader, e.g. in such a way that automatic visual contact takes place when the identification certificate is presented.

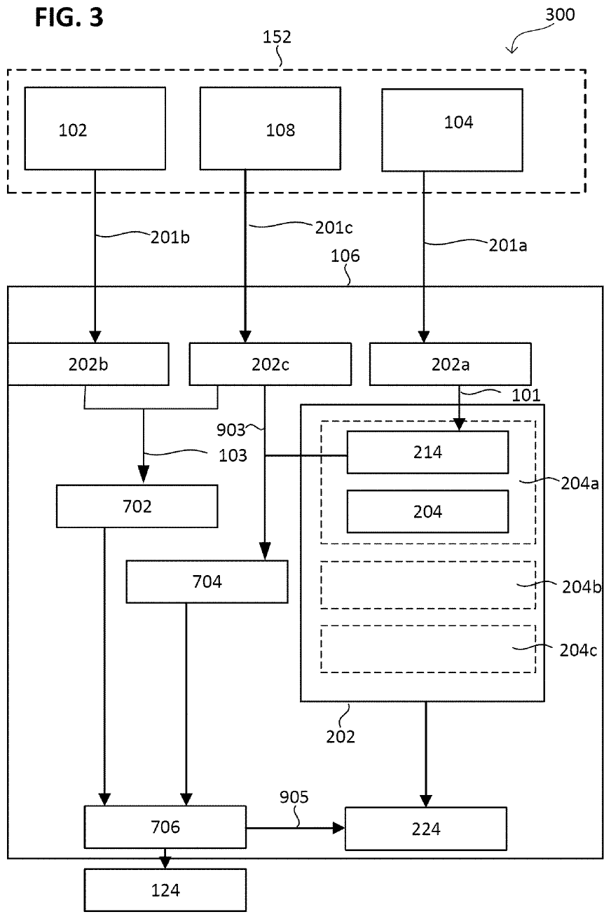

FIG. 3 illustrates a checkout terminal 300 in accordance with various embodiments in a schematic communication diagram. Optionally, the checkout terminal 300 can comprise an information output device 124 which can comprise one or more than one display device and/or one or more than one loudspeaker.

The capture device 152 (e.g. the image capture device 102 thereof) can be configured to feed 201b to the control device 106 captured image data 202b (e.g. in the raw data format or a preprocessed version of the raw data format), e.g. as a single image or continuously as a sequence. The capture device 152 (e.g. the product capture device 104 thereof) can be configured to feed 201a a captured product identifier 202a to the control device 106. The capture device 152 (e.g. the certificate capture device 108 thereof) can be configured to feed 201c the biometric data 202c to the control device 106.

Examples of the biometric data can comprise the following information: facial features (e.g. image data of the face), fingerprint image, genetic fingerprint, iris features (e.g. features of the iris), ocular fundus features (i.e. features of the retina), height, nail bed pattern, signature features, date of birth, place of birth, name, origin, nationality. It may be understood that other biometric data can also be used.

The control device 106 can be configured for determining 101 a sales restriction 214 on the basis of the product identifier 202a. The sales restriction 214 can illustratively restrict the set of persons who are permitted to purchase the product, e.g. only to those persons who satisfy a criterion of the sales restriction 214. In other words, the sales restriction 214 can define a criterion (e.g. comprising one or more than one prerequisite). If a person satisfies the criterion, this person is authorized for example to purchase the product. The sales restriction can be for example a sovereign decree, e.g. standardized by means of a law.

Hereinafter, to facilitate understanding, reference is made to an age restriction, that is to say that the person satisfies the criterion if said person is of a specific age. The description appertaining to the age restriction can analogously also apply to some other sales restriction, e.g. a restriction with regard to the legal competence of the person, with regard to a (e.g. legal) status of the person (e.g. a student status), with regard to a qualification/expertise of the person (e.g. in the case of a fishing license), with regard to a proof of health of the person, or with regard to a permission sovereignly granted to the person (e.g. a driver's license or an authorization to conduct explosions).

The control device 106 can furthermore be configured, in 101, for determining payment information 204 on the basis of the product identifier 202a (also referred to as payment information determining). The payment information 204 can illustratively represent what price is invoked for the corresponding product with the product identifier 202a. By way of example, the captured product identifier 202a can be compared with a database for this purpose.

By way of example, the control device 106 can be configured to start a checkout session 202, e.g. in response to a determined event (also referred to as session start event) which represents that a self-service checkout is intended to be effected. Examples of the session start event can comprise a user standing in front of the checkout terminal 200 and/or performing a corresponding input on the latter, a product having been presented to the capture device 152, and/or a previous checkout session having ended.

In a similar manner, the control device 106 can be configured to end the checkout session 202, e.g. in response to a determined event (also referred to as session end event) which represents that billing of the self-service checkout is intended to be effected. Examples of the session end event can comprise a user performing a corresponding input on the checkout terminal 300, a bank card or some other payment means having been detected by the checkout terminal 300, and/or a predefined time period having elapsed since the last product was captured.

For the purpose of ending the checkout session 202, the control device 106 can be configured to determine billing information 224 and to output it by means of an information output device of the checkout terminal 300. The payment information 204 determined during a checkout session 202 can be aggregated, for example, and the result of the aggregating the purchase of more than one product (referenced by 204a, 204b, 204c) for the billing information 224. The billing information 224 can illustratively indicate what total to be paid is produced by the registered products. The billing information 224 can optionally comprise further information, such as, for example, the proportion of taxes, a list of the products captured, an itemized list of the products captured, or the like.

In order to end the checkout session 202, a payment process can furthermore be initiated, by means of which the sum to be paid can be settled in accordance with the billing information 224. The settling can be effected for example by means of the payment means terminal (not illustrated).

In order to carry out the comparison between the person who would like to buy the product and the sales restriction, the captured biometric data can comprise at least two different items of information (also referred to as first biometric information and second biometric information), as will be described in more specific detail below.

The first biometric information (e.g. comprising or formed from image information) can be configured for example to be compared with the image data. The second biometric information can be configured for example to be compared with the criterion. In other words, information/data able to be compared with one another can be used.

The control device 106 can furthermore be configured for comparing 103 the image data 202b with the biometric data 202c (e.g. the first biometric information thereof). The result 702 of the comparing 103 (also referred to as biometric comparing 103 for simplification) may be for example that the image data 202b of the person and the biometric data 202c (e.g. the first biometric information) match (as a positive result) or do not match (as a negative result). Optionally, between the two results of matching as a positive result and non-matching as a negative result, one or more than one intermediate step (e.g. as many intermediate steps as desired) representing partial matching can be used. By way of example, the result 702 of the comparing 103 can comprise a degree of matching, where the result of complete matching corresponds to a degree of 100% and the result of non-matching corresponds to a degree of 0%. If the degree of matching exceeds a stored threshold value, the positive result can be output, for example.

Illustratively, the biometric comparing 103 can provide a person correlation, for example, which involves checking whether the identity certificate belongs to the person from whom the image data 202b were captured, e.g. whether this person is actually the owner of the identity certificate.

The control device 106 can furthermore be configured for comparing 903 the sales restriction 214 with the biometric data 202c (e.g. the second biometric information thereof). The result 704 of the comparing 903 (also referred to as restriction comparing 903) may be, for example, that the biometric data 202c (e.g. the second biometric information thereof) of the person satisfies the criterion of the sales restriction (as a positive result) or does not satisfy it (as a negative result). Optionally, between the two results of satisfying as a positive result and non-satisfying as a negative result, one or more than one intermediate step (e.g. as many intermediate steps as desired) representing partial satisfying of the criterion can be used. By way of example, the result 704 of the comparing 903 can comprise a degree of satisfying, where the result of complete satisfying corresponds to a degree of 100% and the result of non-satisfying corresponds to a degree of 0%. The intermediate steps make it possible to handle more complex sales restrictions that define a set of prerequisites for purchasing the product, for example, as a criterion. If the degree of satisfying exceeds a stored threshold value, the positive result can be output, for example.

Illustratively, the restriction comparing 903 can provide a correlation, for example, which involves checking whether the person from whom the image data 202b were captured actually satisfies the prerequisites for purchasing the product.

If both the restriction comparing 903 and the biometric comparing 103 yield a positive result, it is possible to determine as the result 706 that the person (from whom the image data 202b were captured) satisfies the criterion of the sales restriction. If the restriction comparing 903 and/or the biometric comparing 103 yield(s) a negative result, it is possible to determine as the result 706 that the person (from whom the image data 202b were captured) does not satisfy the criterion of the sales restriction.

It may be understood that the control device 106 can optionally be configured to request the person to present himself/herself (e.g. his/her face) and/or the identity certificate to the capture device 152, e.g. by means of an information output device of the checkout terminal 300. By way of example, the person can be requested as often as possible to present himself/herself and/or the identity certificate if a negative result 702, 704 is obtained.

Optionally, the control device 106 can be configured to output a signal 905 configured for example (e.g. by means of instructions) to intervene in the checkout session 202 (or some other process of the checkout terminal 300) and/or to actuate one or more than one component of the checkout terminal 300, e.g. in order to output perceptible information representing the result 706.

If it is determined that the person does not satisfy the criterion of the sales restriction, by means of the signal 905 it is possible for the checkout session 202 to be put into a standby state, for an alarm to be output and/or for the payment procedure to be blocked. It is thus possible for example to establish an obstacle preventing the person from purchasing the product.

If it is determined that the person satisfies the criterion of the sales restriction, by means of the signal 905 it is possible for the checkout session 202 to be continued, it is possible for the alarm to be canceled and/or it is possible for the payment procedure to be enabled. It is thus possible for example to enable the person to purchase the product. Enabling the payment procedure can comprise for example actually carrying out debiting (e.g. of a reserved accounting transaction).

Optionally, it is possible (e.g. depending on the security level) for the checkout session 202 automatically to be put into a standby state and/or for the payment procedure to be blocked, in response to the presence of the sales restriction being determined. It is then possible for the signal 905 to be output (e.g. only then) in order to cancel the blocking and/or the standby state.

However, if the checkout session 202 is not automatically put into the standby state and/or the payment procedure is not automatically blocked, it is possible, in response to the person not satisfying the criterion of the sales restriction, for the signal to be output in order to bring about the blocking and/or the standby state.

If the alarm is output, which can be for example a perceptible alarm or else a silent alarm, it may be necessary for this alarm to be acknowledged by means of an authentication of an employee, e.g. in order to cancel the blocking and/or the standby state.

Optionally, the control device 106 can be configured to output, by means of the information output device 124, a feedback message with respect to the capturing of the image data of the person and/or the biometric data of the official identity certificate. By way of example, the captured image data can be output directly by means of the information output device 124. This facilitates the capture of usable image data. Optionally, a positioning template (for example a contour, a stencil or a frame) indicating a position to be occupied by the person can additionally be superposed on the reproduced image data.

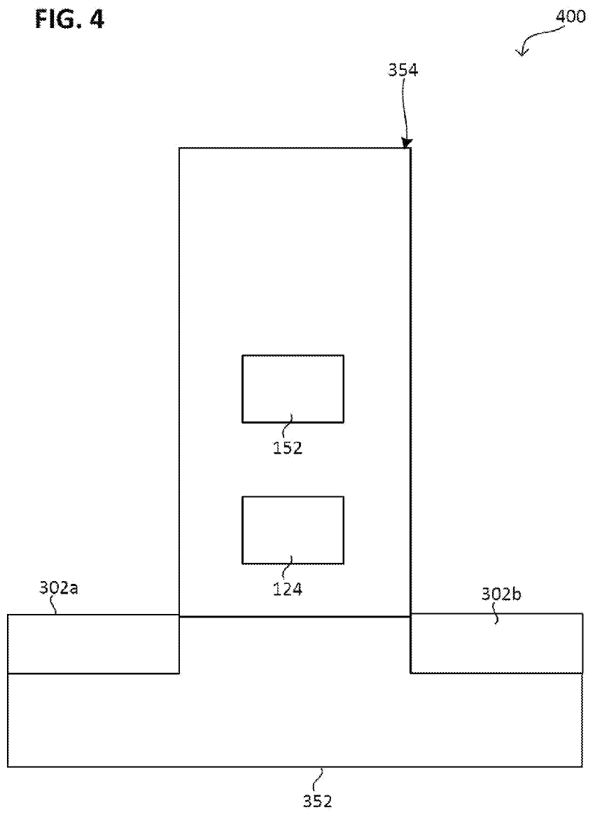

FIG. 4 illustrates a checkout terminal 400 in accordance with various embodiments in a schematic side view, in which the checkout terminal 400 is configured for example as a self-service checkout terminal 400 (also referred to as SS checkout terminal).

The checkout terminal 400 can generally comprise a supporting structure 352, by means of which various components of the checkout terminal 400 are supported, for example one or more than one placement device 302a, 302b, the capture device 152 (e.g. the product capture device 104 and/or image capture device 102 thereof), the control device (not illustrated), etc. The supporting structure 352 can comprise for example a framework and a housing secured thereto, wherein the housing houses the sensitive components of the checkout terminal 400. The supporting structure 352 can comprise for example a base, by which the supporting structure 352 stands on a surface underneath, and a vertically extended section 354 (illustratively also referred to as pole), which supports the components attached in an elevated fashion, e.g. the image capture device 102 and the product capture device 104.

The capture device 152 (e.g. the image capture device 102 thereof) can be configured to capture image data, e.g. of a person in front of the checkout terminal 400. For this purpose, the capture device 152 can comprise one or more than one camera. By way of example, the capture device 152 can be configured to generate image data comprising depth information (e.g. of the person).

For determining the depth information, the capture device 152 can comprise for example one or more than one 3D camera (also referred to as 3-dimensional camera). A 3D camera can generally be configured to capture image data comprising the depth information.

Examples of a 3D camera comprise: a plenoptic camera (also referred to as a light field camera), a stereoscopic camera (also referred to for short as stereo camera), a camera with a triangulation system, a TOF camera (time of flight camera), a camera with an interference system. In this case, a stereo camera is a particularly cost-effective 3D camera that is easier to implement. A stereo camera is likewise more robust vis-à-vis reflective surfaces and does not require a laser, which reduces the health risk for persons in public spaces.

The TOF camera can be configured for example to illuminate the capture region in front of the checkout terminal 400 by means of a light pulse and to capture for each pixel a time (the so-called time of flight) needed by the light pulse to return again. In general, however, a signal of a different type (e.g. sound) can also be used in order to measure a spatial distribution of the time of flight of the signal (e.g. an ultrasonic time of flight method). This makes it possible for example to use a camera constructed even more simply or to provide a higher image resolution in comparison with a light pulse, depending on the underlying technology.

Alternatively or additionally, a different mechanism can also be used in order to provide the depth information. By way of example, the camera can be configured to use a variable focus (autofocus) for determining the depth information. However, the focus can also be directed at a movable object (e.g. product and/or hand), such that the distance between the camera and the object can be determined as depth information on the basis of the focus position. Alternatively or additionally the depth information can be determined on the basis of an edge contrast measurement and/or a phase comparison.

The or each placement device 302b, 302a can be configured in such a way that one or more than one product can be placed thereon. For this purpose, a placement device 302b, 302a can comprise for example a placement shelf, a placement hook for bags and/or a placement table. Optionally, the or each placement device 302b, 302a can have scales configured to detect a weight of the products placed on the placement device.

Optionally, the checkout terminal 400 can comprise the information output device 124. The information output device 124 can be configured for example to output (e.g. audible or visible) information perceptible to humans, e.g. by means of a display device. The information can comprise for example a request and/or support (e.g. for the user).

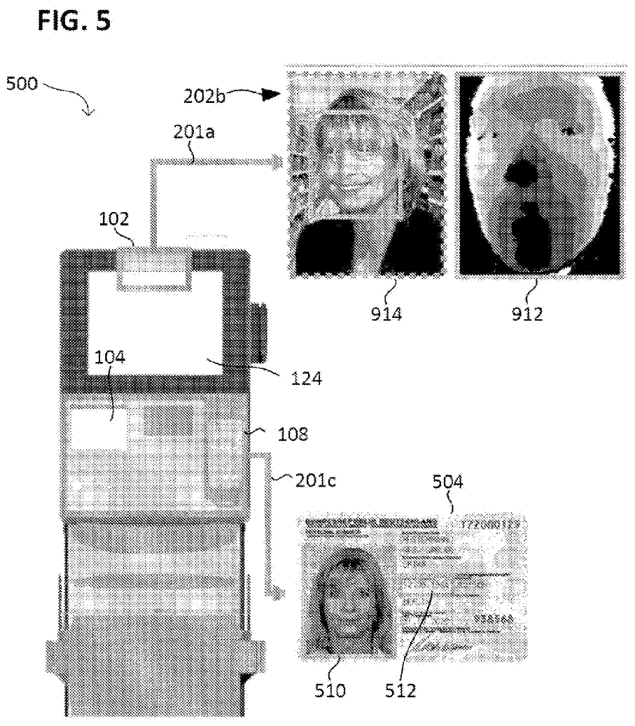

FIG. 5 illustrates a checkout terminal 500 in accordance with various embodiments in the method 100 in a schematic side view.

Hereinafter, to facilitate understanding, reference is made to an identity card 504 as identity certificate. The description appertaining to the identity card 504 can analogously also apply to some other identity certificate, for example a driver's license, a certificate of nationality, a social security identity card, a fishing license, a certificate of qualification (e.g. for handling explosive substances), a passport or the like.

Furthermore, to facilitate understanding, reference is made to a photograph 510 (i.e. a photo) as first biometric information. The description appertaining to the photograph 510 can analogously also apply to some other biometric information, e.g. biometric information captured by means of pattern recognition. Furthermore, to facilitate understanding, reference is made to a date of birth (i.e. a date indication) as second biometric information 512. The description appertaining to the date of birth can analogously also apply to some other biometric information, e.g. biometric information captured by means of text recognition.

The certificate capture device 108 can be or have been provided for example by means of the payment means terminal or separately therefrom.

The image data 202b captured by means of the capture device 152 can comprise color image data 914 and/or depth image data 912. The color image data 914 can comprise a pixel matrix with (monochromatic or polychromatic) color information, wherein the color information indicate as a value of each pixel the color value thereof. The depth image data 912 can comprise a pixel matrix with depth information, wherein the depth information indicate as a value of each pixel the depth value thereof.

The depth image data 912 and the color image data 914 can be captured by means of the same camera or by means of separate cameras (e.g. cameras separated from one another). For example, a 3D camera can determine the depth image data 912 and an RGB camera can determine the color image data 914.

The depth image data 912 can be or have been provided by means of a stereo camera as 3D camera, for example. A stereo camera can comprise a plurality of (e.g. two) lenses arranged next to one another and directed at the capture region in front of the checkout terminal 200. The plurality of lenses can be configured to image the capture region onto one or more than one image capture sensor of the capture device 152. The image capture sensor can be infrared-sensitive, for example, i.e. capture infrared radiation.

By means of the stereo camera, illustratively, image data 202b are captured which represent a plurality of perspectives of the person at the same time (also referred to as stereoscopic image data), i.e. which represent the person as viewed from different directions and/or from different locations. For this purpose, the exposure control and/or the focusing of the lenses can be coupled to one another, for example.

The depth information can be determined on the basis of the stereoscopic image data of the person. By way of example, the different perspectives of the stereoscopic image data can be superposed on one another and the depth information can be derived therefrom. The description given appertaining to the stereoscopic camera can analogously also apply to a differently configured capture device 152 that implements a different mechanism in order to provide the depth information.

In general, the depth information 912 can comprise information which establishes a spatial relationship relating a plurality of segments of the image data to one another and/or to a reference object. The corresponding image data segment can be assigned a respective depth value representing the spatial relationship. By way of example, individual pixels (e.g. the depth information 912 can be resolved pixelwise) or a plurality of pixels (the so-called pixel group) can be used as image data segment. The reference object can comprise or be formed from the capture device 152, for example. By way of example, the depth information can indicate pixelwise a distance from the reference object as depth value.

The biometric comparing 103 can comprise carrying out a first facial recognition on the basis of the captured image data 202b of the person, e.g. the depth image data 912 and/or the color image data 914.

Optionally, the first facial recognition can comprise carrying out living recognition. The living recognition can illustratively determine whether the image data 202b represent a living person or a non-living object. This can make it possible for example to discover the attempted fraud by means of a photo of the person.

The living recognition can comprise for example determining, on the basis of the depth information, whether a real person (e.g. the face thereof) is involved, or only the optical reproduction of the person is involved (e.g. by means of a photo). However, it is also possible to implement some other form of living recognition that does not necessarily use the depth information. The living recognition can for example likewise be effected on the basis of a sequence of color image data 914 (e.g. a video), for example by determining how and whether the person captured from the image data 202b is moving. By way of example, the alteration of facial features can be captured if the person is living. The period of time before and/or after capturing the image data fed to the biometric comparing 103 can likewise be implemented in order to determine whether the person is living.

Other examples of living recognition comprise a request for sequential blinking and capture thereof (also referred to as a blinking test), a request for sequential inclination of the head in different directions and capture thereof (also referred to as an inclination test), sensors for capturing microscopic involuntary muscular contractions in specific regions of the face with the aid of illumination and capture outside the visible spectrum (also referred to as a twitch test); capturing the eye movement after a request to follow a point on the screen; extracting a biometric feature and verified blood flow in the veins on the basis of a finger or hand vein analysis.

However, the blinking test and the inclination test may be a hindrance to the given problem for reasons of user-friendliness and primarily the intended acceleration of the procedure. Furthermore, the blinking test and the inclination test require complex instructions to the user. The twitch test is used for example at border control stations (e.g. at airports) and is thus established and robust. However, the twitch test may cause higher costs for implementation or problems owing to the structural size.

By contrast, the plausibility check with the aid of the depth information requires no additional action whatsoever on the part of the user, is cost-effective and is very robust relative to the environment.

By way of example, if it is not possible to determine that the person whose image data 202b were captured is living, a negative result of the biometric comparing 103 can be output.

The biometric comparing 103 can comprise carrying out a second facial recognition on the basis of image data of the identity card 504, e.g. on the basis of the photograph 510 of the identity card 504. For this purpose, the identity card can be captured by the camera or an additional camera, for example. This has the advantage, for example, that identity cards that do not have a data memory can also be processed. This has the advantage, alternatively or additionally, that the data memory of the identity card need not be read, and so there is no need to intrude on a sovereign right. By way of example, depending on the prevailing legal situation, non-sovereign institutions may be prohibited from reading out the biometric data of an identity card 504 without authorization. Optionally, the image data of the identity card 504 can represent the front side and/or rear side of the identity card.

The biometric comparing 103 can furthermore comprise comparing the result of the first facial recognition (also referred to as first facial features for simplification) and the result of the second facial recognition (also referred to as second facial features for simplification) with one another, for example checking them for a match. The result 702 of the biometric comparing 103 may be, for example, that the first facial features and the second facial features match (as a positive result) or do not match (as a negative result). Optionally, one or more than one intermediate step (e.g. as many intermediate steps as desired) representing a partial match can be used between the two results of matching as a positive result and non-matching as a negative result. By way of example, the result can comprise a degree of matching of the facial features, where the result of complete matching corresponds to a degree of 100% and the result of non-matching corresponds to a degree of 0%. If the degree of matching of the facial features exceeds a stored threshold value, the positive result can be output, for example.

In one easily understandable example, live facial recognition can be effected, for example by means of an Intel RealSense camera as an image capture device 102. This image capture device 102 can capture facial depth information 912 and facial color information 914, for example, which can be fed to the biometric comparing 103. Illustratively, the facial depth information 912 and/or facial color information 914 can serve as reference image data, for the biometric comparing 103.

In one easily understandable example, optical card capturing can be effected, e.g. by means of a Gemalto CR5400 as a certificate capture device 108. By way of example, the photo of the person, the date of birth (and thus the age) of the person and/or the validity of the identity card 504 can be checked on the basis of the optical card capturing.

The restriction comparing 903 can comprise determining the date of birth 512 on the basis of the image data of the identity card 504. By way of example, any desired process of text recognition can be used for this purpose. Furthermore, on the basis of the date of birth 512, it is possible to determine the age of the person at the time of capturing the image data 202b. For this purpose, the date of birth can be subtracted from the date at the time of capturing the image data 202b.

The restriction comparing 903 can optionally comprise determining the validity of the identity card 504. If it has been determined that the identity card is not valid, a negative result of the restriction comparing 903 can be output.

In one easily understandable example, the criterion of the sales restriction comprises for example a minimum age, e.g. in order to be permitted to purchase the product. In other words, the person satisfies the criterion of the sales restriction if this person is of the minimum age or older. If it is determined, for example, that the age of the person is greater than or equal to the minimum age, the result of the restriction comparing 903 can be positive.

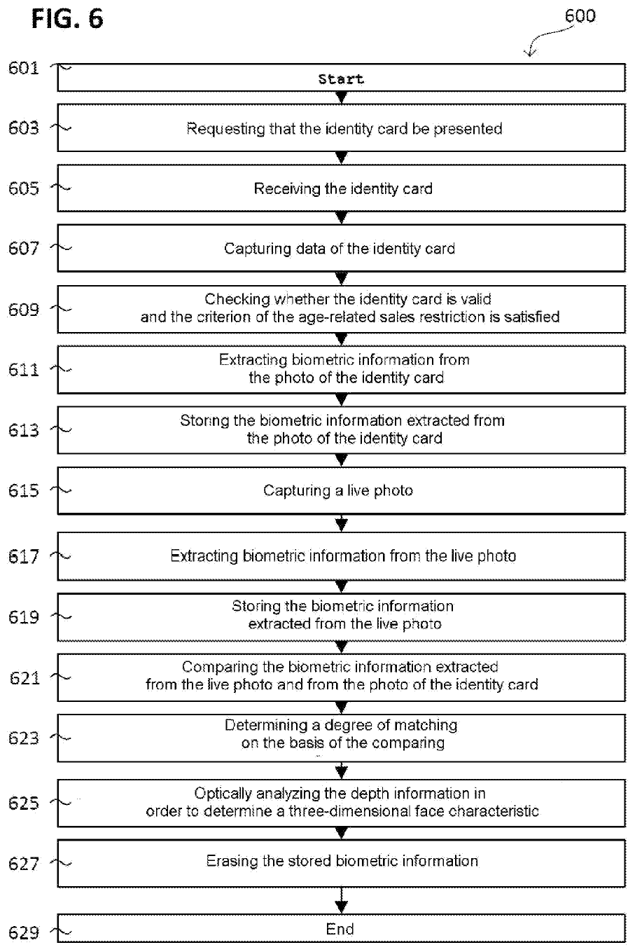

FIG. 6 illustrates a method 600 in accordance with various embodiments in a schematic flow diagram.

The method 600 can comprise, in 601, a start of the age verification. The age verification can be started in response to determining an event which requires an age verification. The event can comprise, for example, the fact that an age-related sales restriction to which the product is subject was determined 101 (cf. FIG. 1). The method 600 can comprise, in 603, requesting that the identity card be presented. Requesting that the identity card be presented can be effected for example by means of the information output device 124, e.g. optically and/or acoustically.

The method 600 can comprise, in 605, receiving the identity card, for example by means of the certificate capture device 108. For this purpose, the identity card can be inserted into the certificate capture device 108, for example.

The method 600 can comprise, in 607, capturing data of the identity card (e.g. a validity, a photo, a date of birth and/or a checksum). By way of example, a cyclic redundancy check can be effected by means of the checksum.

The method 600 (e.g. the process of secondly determining 105) can comprise, in 609, checking whether the identity card is valid and the criterion of the age-related sales restriction is satisfied, as referenced by 903 in FIG. 3; in 611, extracting biometric information from the photo of the identity card; optionally, in 613, storing the biometric information extracted from the photo of the identity card; in 615, capturing a live photo (optionally with depth information) of the person; in 617, extracting biometric information from the live photo; optionally, in 619, storing the biometric information extracted from the live photo.

The method 600 (e.g. as referenced by the biometric comparing 103 FIG. 3) can comprise, in 621, comparing the biometric information extracted from the live photo and from the photo of the identity card; and, in 623, determining a degree of biometric matching on the basis of the comparing 621 (in a manner similar to 103).

The method 600 (e.g. the process of secondly determining 105) can comprise, optionally in 625, optically analyzing the depth information in order to determine a three-dimensional face characteristic; and optionally, in 627, erasing the stored biometric information.

The method 100 can comprise, in 629, ending the age verification. Ending the age verification can comprise outputting a result 706, as referenced in FIG. 3, of the age verification. The result 706 of the age verification can comprise for example the result of the comparing 621, the result of the checking 609 and/or the result of determining 623 the degree of matching.

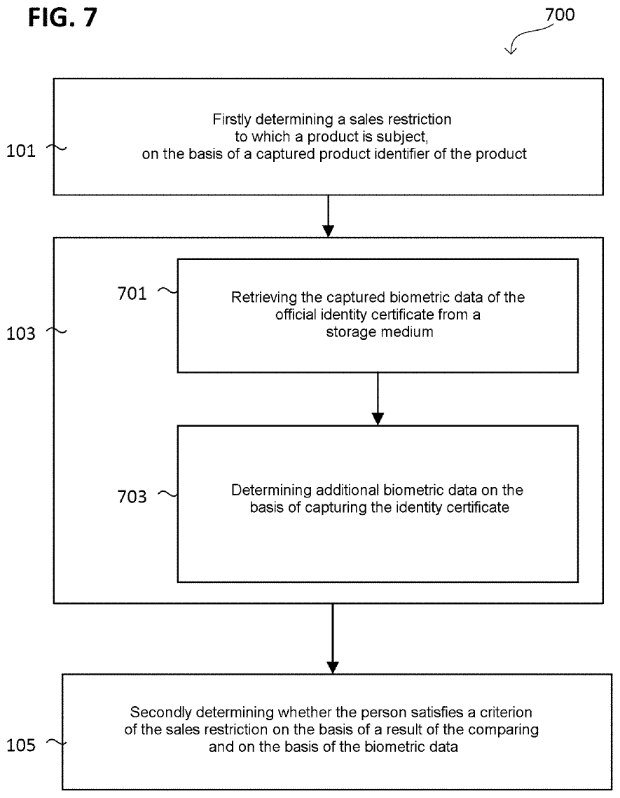

FIG. 7 illustrates a method 100 in accordance with various embodiments 700 in a schematic flow diagram. The method 700 includes steps 101 and 105 which are shown in FIG. 1 and described above.

Although not shown in FIG. 7, the method 700 can comprise storing the captured biometric data, e.g. on a storage medium of the control device 106 and/or a stored database, for example. In other words, the captured biometric data can be stored in the meantime and retrieved again at a later time. By way of example, the biometric data captured during each checkout session 202 can be stored in a database.

Accordingly, as shown in FIG. 7, the comparing 103 can comprise: retrieving the captured biometric data of the official identity certificate from a storage medium, as referenced at 701.

By way of example, in the course of the first use of the checkout terminal 200 by a person, in response to a successful age verification, the captured biometric data of the person can be stored in the database, such that upon any further use, said person no longer need (but can) be asked for his/her sovereign document. This can optionally furthermore require the person to have been determined as living (i.e. positive living recognition).

If, at a later time, in response to determining 101 the sales restriction, the image data of the person are captured, they can first be compared with the stored biometric data (if present), e.g. by means of comparison between the live facial recognition and all entries already available in the database.

The database can analogously be supplemented with biometric identification features and corresponding authorizations from a different process. These can then in turn be used at a later time.

One example for implementing the method 700 can comprise: firstly determining 101 the sales restriction 214 to which a product is subject, on the basis of a captured product identifier 202a of the product, for example by virtue of the person scanning a product subject to age restriction (example: over eighteen years of age); optionally outputting a request to the person to present himself/herself (e.g. the face) to the capture device, for example by the checkout terminal 200 asking the person for a “live face”; capturing image data of the person (e.g. the face thereof); determining biometric data of the person on the basis of the image data of the person, e.g. by these being extracted from the image data of the person; optionally carrying out living recognition on the basis of the image data of the person; comparing 621 the biometric data determined on the basis of the image data of the person with stored, previously captured biometric data, in a database (e.g. over eighteen years of age database).

If the comparing 621 yields a positive result, the payment procedure can be enabled. This can make it possible for example for the person to purchase the product.

If the comparing 621 yields a negative result and/or if the database has no matching data set (also referred to as entry), the method 700 can furthermore comprise the following: optionally outputting a request to the person to present the identity certificate to the capture device, for example by the checkout terminal 200 asking the person for a sovereign document; capturing the identity certificate, e.g. by image data of the identity certificate being captured (e.g. front side and/or rear side of the identity certificate); determining 703 additional biometric data on the basis of capturing the identity certificate, e.g. by these being extracted from the image data of the identity certificate; and additionally comparing 621 the biometric data determined on the basis of the image data of the person with the additional biometric data captured from the identity certificate as shown in FIG. 1 at step 103.

If it is determined that the person satisfies the criterion of the sales restriction 214 on the basis of the biometric data captured from the identity certificate, the process of additionally comparing 103 can be carried out. Otherwise, by means of the signal 905 shown in FIG. 3, the checkout session 202 can be put into a standby state, the alarm can be output and/or the payment procedure can be blocked. Illustratively, by way of example, the biometric data are extracted from a sovereign document and a check is made to ascertain whether the age of the person is above 18 (also referred to as over eighteen years of age).

If the process of additionally comparing 103 yields a positive result, the payment procedure can be enabled. Otherwise, by means of the signal 905, the checkout session 202 can be put into a standby state, an alarm can be output and/or the payment procedure can be blocked.

If the process of additionally comparing 103 yields a positive result, the biometric data captured with reference to the identity certificate, such as completed in step 611, can be stored in the database (e.g. such as an over eighteen years old database).

The database thus formed contains, for example, only extracted biometric data without a link to identities of persons and/or without image data. Optionally, no image data, e.g. image representations of faces, can be reconstructed from these biometric data purely by virtue of the conceptual implementation by means of an ANN. The database thus remains anonymous per se. Just the presence of the biometric data of a person in a (e.g. over eighteen years old) database makes it possible to verify again in an accelerated manner the authorization of the person to purchase the product which is subject to a sales restriction (e.g. over eighteen years old article).

In various embodiments, the database can for example be stored locally on a storage medium of the checkout terminal 200; be stored centrally in a retail store on a storage medium that can be accessed by a plurality of checkout terminals of the same retail store; or be stored centrally on a storage medium that can be accessed by the checkout terminals of a plurality of retail stores (e.g. of the same chain of stores), e.g. via a network.

A description is given below of various examples which relate to what is described above and what is illustrated in the figures.

Example 1 is a checkout terminal (e.g. comprising a self-service checkout terminal or a cashier workstation), comprising: a capture device having at least one sensor, wherein the capture device is configured: to capture first biometric data (e.g. by means of capturing image data) with reference to a person at the self-service checkout terminal (e.g. if the person is presented to the capture device); to capture second biometric data with reference to an official identity certificate if the identity certificate is presented to the capture device; and to capture a product identifier of a product if the product is presented to the capture device; a control device configured for: firstly determining a sales restriction to which the product is subject, on the basis of the product identifier; comparing the first biometric data (e.g. the image data) with the second biometric data (e.g. in reaction to the process of firstly determining); secondly determining whether the person satisfies a criterion of the sales restriction on the basis of a result of the comparing and on the basis of the second biometric data.

Example 2 is the checkout terminal (e.g. self-service checkout terminal) in accordance with example 1, furthermore comprising: enabling a payment procedure process for the product if the person satisfies the criterion of the sales restriction, otherwise putting the payment procedure process into a standby state and/or outputting an alarm signal.

Example 3 is the checkout terminal (e.g. self-service checkout terminal) in accordance with example 1 or 2, wherein the capture device comprises an image capture sensor configured to capture image data of the identity certificate which comprise the second biometric data.

Example 4 is the checkout terminal (e.g. self-service checkout terminal) in accordance with any of examples 1 to 3, wherein the capture device comprises a smart card reader configured to read out the second biometric data stored on the identity certificate.

Example 5 is the checkout terminal (e.g. self-service checkout terminal) in accordance with any of examples 1 to 4, wherein the identity certificate comprises a photographic identity card, which for example is captured optically by means of the capture device.

Example 6 is the checkout terminal (e.g. self-service checkout terminal) in accordance with any of examples 1 to 5, wherein the capture device is furthermore configured to carry out living recognition on the basis of the first biometric data, wherein for example secondly determining whether the person satisfies the criterion of the sales restriction (214) is furthermore effected on the basis of a result of the living recognition.

Example 7 is the checkout terminal (e.g. self-service checkout terminal) in accordance with any of examples 1 to 6, wherein the capture device is configured to capture image data of the person which comprise the first biometric data.

Example 8 is the checkout terminal (e.g. self-service checkout terminal) in accordance with any of examples 1 to 7, wherein the capture device is furthermore configured to capture depth information assigned to the image data of the person, wherein the control device is configured to carry out living recognition and/or facial recognition on the basis of the depth information.

Example 9 is the checkout terminal (e.g. self-service checkout terminal) in accordance with any of examples 1 to 8, wherein secondly determining whether the person satisfies the criterion of the sales restriction is furthermore effected on the basis of a result of the living recognition.

Example 10 is the checkout terminal (e.g. self-service checkout terminal) in accordance with any of examples 1 to 9, wherein the criterion of the sales restriction comprises a minimum age of the person.

Example 11 is the checkout terminal (e.g. self-service checkout terminal) in accordance with example 10, wherein the process of secondly determining takes account of an age of the person determined on the basis of the first and/or second biometric data.

Example 12 is the checkout terminal (e.g. self-service checkout terminal) in accordance with example 11, wherein the age of the person is determined on the basis of a date (e.g. date of birth) of the second biometric data.

Example 13 is the checkout terminal (e.g. self-service checkout terminal) in accordance with any of examples 1 to 12, wherein comparing the first biometric data (e.g. image data of the person) with the second biometric data comprises carrying out one or more than one facial recognition, e.g. one facial recognition on the basis of the first biometric data (e.g. the image data of the person) and/or one facial recognition on the basis of the second biometric data.

Example 14 is the checkout terminal (e.g. self-service checkout terminal) in accordance with any of examples 1 to 13, furthermore comprising: an information output device for outputting perceptible information; wherein the control device is furthermore configured to output (e.g. on the basis of a result of the process of firstly determining), by means of the information output device, the perceptible information comprising a request to present the identity certificate and/or the person (e.g. the face thereof) to the capture device.

Example 15 is the checkout terminal (e.g. self-service checkout terminal) in accordance with any of examples 1 to 14, wherein the control device is furthermore configured to store (e.g. on a storage medium) biometric data captured by means of the capture device (e.g. the first biometric data and/or the second biometric data) if the process of secondly determining reveals that the person satisfies the criterion of the sales restriction on the basis of the result of the comparing and on the basis of the second biometric data.

Example 16 is the checkout terminal (e.g. self-service checkout terminal) in accordance with any of examples 1 to 15, wherein the control device is configured: to read out the biometric data used as second biometric data from a memory and/or to capture them by means of the capture device.

Example 17 is the checkout terminal (e.g. self-service checkout terminal) in accordance with any of examples 1 to 16, wherein the control device is furthermore configured to capture, by means of the capture device, the second biometric data with reference to the official identity certificate if (e.g. only if) it is determined that no biometric data are stored for which (i.e. if these are used as second biometric data) the process of secondly determining reveals that the person satisfies the criterion of the sales restriction.

Example 18 is the checkout terminal (e.g. self-service checkout terminal) in accordance with any of examples 1 to 17, wherein the information output device is configured to display the first biometric data or image data of the person captured by means of the capture device (e.g. as a sequence).

Example 19 is a method, comprising: firstly determining a sales restriction to which a product is subject, on the basis of a captured product identifier of the product; comparing first biometric data (e.g. image data) of a person, said first biometric data being captured with reference to the person, with second biometric data captured with reference to an official identity certificate; secondly determining whether the person satisfies a criterion of the sales restriction on the basis of a result of the comparing and on the basis of the second biometric data.

Example 20 is a control device configured to carry out the method in accordance with example 19.

Example 21 is a non-volatile storage medium comprising code segments which are configured, when executed by a processor, to carry out the method in accordance with example 19.

Example 22 is the checkout terminal, comprising: a capture device for capturing the product identifier, the first biometric data (e.g. the image data of the person) and/or the second biometric data; and the control device in accordance with example 20.

Example 23 is a terminal (e.g. a self-service terminal), comprising: a capture device having at least one sensor, wherein the capture device is configured: to capture first biometric data (e.g. by means of capturing image data) with reference to a person at the terminal (e.g. if the person is presented to the capture device); to capture second biometric data with reference to an official identity certificate if the identity certificate is presented to the capture device; and to capture a user input representing a (e.g. physical or virtual) product offered by the terminal; a control device configured for: firstly determining a sales restriction to which the product is subject; comparing the first biometric data (e.g. the image data) with the second biometric data (e.g. in reaction to the process of firstly determining); secondly determining whether the person satisfies a criterion of the sales restriction on the basis of a result of the comparing and on the basis of the second biometric data.

Example 24 is the terminal (e.g. self-service checkout terminal) in accordance with example 23, which is furthermore configured in accordance with any of examples 1 to 18.

1. A self-service checkout terminal comprising:
an image capture device having at least one first sensor and configured to capture a live photograph of a purchaser at the self-service checkout terminal;
a certificate capture device configured to receive an identity certificate from the purchaser at the self-service checkout terminal;
a product capture device configured to capture a product identifier of a product being purchased by the purchaser at the self-service checkout terminal;
a control device configured for:
extracting first biometric data associated with the purchaser from the live photograph;
extracting depth information from the live photograph;
extracting second biometric data from the identity certificate;
detecting a face of the purchaser in the live photograph based on the depth information;
firstly determining a sales restriction to which the product is subject, on the basis of the product identifier;
comparing the first biometric data with the second biometric data and thereby confirming that the first biometric data matches the second biometric data;
perform a living detection;
secondly determining whether the purchaser satisfies a criterion of the sales restriction on the basis of a result of said comparing, on the basis of the second biometric data, on the basis of said detecting, and on the basis of said performing the living detection.

2. The self-service checkout terminal as claimed in claim 1 enabling wherein the control device is further configured to complete a payment procedure process for the product in response to said secondly determining.

3. The self-service checkout terminal as claimed in claim 1 wherein the certificate capture device comprises an a second sensor configured to capture image data of the identity certificate which comprises the second biometric data.

4. The self-service checkout terminal as claimed in claim 1 wherein the certificate capture device comprises a smart card reader configured to read out the second biometric data stored on the identity certificate.

5. The self-service checkout terminal as claimed in claim 4 wherein the smart card reader is configured to read a photograph on the identity certificate.

6. (canceled)

7. The self-service checkout terminal as claimed in claim wherein the control device is further defined as configured to carry out said performing the living recognition on the basis of the depth information.

8. The self-service checkout terminal as claimed in claim 1, wherein the criterion of the sales restriction comprises a minimum age of the person purchaser.

9. (canceled)

10. The self-service checkout terminal of claim 1, furthermore comprising:
an information output device configured to output perceptible information; and
wherein the control device is furthermore configured to output, by means of the information output device, the perceptible information comprising a request to present at least one of the identity certificate and the person to the image capture device.

11. (canceled)

12. A method of operating a checkout terminal comprising:
firstly capturing, with a product capture device of the checkout terminal, a product identifier uniquely assigned to a product to be purchased;
firstly determining, with a control device of the checkout terminal, a criterion of a sales restriction to which the product is subject, said firstly determining the criterion on the basis of the captured product identifier of the product;
secondly capturing, with an image capture device of the checkout terminal, a live photograph of a purchaser of the product;
extracting, with the control device, first biometric data associated with the purchaser from the live photograph;
extracting, with the control device, depth information from the live photograph;
detecting, with the control device, a face of the purchaser in the live photograph based on the depth information;
capturing, with the image capture device, a sequence of color image data of the purchaser;
carrying out, with the control device, a living recognition of the purchaser on the basis of the sequence of color image data;
receiving, with a certificate capture device of the checkout terminal, an identity certificate from the purchaser;
extracting, with the control device, second biometric data from the identity certificate;
comparing, with the control device, the first biometric data of a person with the second biometric data;
secondly determining, with the control device, the purchaser satisfies the criterion of the sales restriction (i) on the basis of a result of said comparing, (ii) on the basis of the second biometric data, (iii) on the basis of a result of the living recognition, and (iv) on the basis of said detection.

13.-15. (canceled)
